(19) United States
(12) Patent Application Publication
(10) Pub. No.: US 2024/0006659 A1
(43) Pub. Date: Jan. 4, 2024

(54) POLYMERISABLE COMPOSITION FOR A SOLID POLYMER ELECTROLYTE

(71) Applicant: The Swatch Group Research and Development Ltd, Marin (CH)

(72) Inventors: Rémy CAMILLO, Cornaux (CH); Nathalie MARINAKIS, Marin-Epagnier (CH)

(73) Assignee: The Swatch Group Research and Development Ltd, Marin (CH)

(21) Appl. No.: 18/163,919

(22) Filed: Feb. 3, 2023

(30) Foreign Application Priority Data
Jul. 4, 2022 (EP) 22182849.4

(51) Int. Cl. H01M 10/0565; H01M 4/38; H01M 10/052

(52) U.S. Cl. CPC H01M 10/0565; H01M 4/382; H01M 10/052; H01M 2004/027

(57) ABSTRACT

One aspect of the invention relates to a polymerisable composition for a solid polymer electrolyte comprising a first polymer comprising a first moiety capable of coordinating cations of an alkaline metal and/or of an alkaline-earth metal and a photo-activable and/or heat-activable second moiety, an oligomer having at least two photo-activable and/or heat-activable groups, a second polymer comprising a third moiety comprising a salt of an alkaline metal or of an alkaline-earth metal, a solvent, and a polymerisation initiator allowing initiating polymerisation between the second moiety of the first polymer and the photo-activable and/or heat-activable groups of the oligomer by the action of a temperature comprised between 20° C. and 150° C. or of a radiation. Other aspects of the invention relate to a solid polymer electrolyte obtained by polymerisation of the polymerisable composition of the invention, a battery element comprising the solid polymer electrolyte, and a method for producing a battery element comprising the solid polymer electrolyte.

### TECHNICAL FIELD OF THE INVENTION

The present invention relates to a composition for a solid polymer electrolyte, the composition being polymerisable. The present invention also relates to a solid polymer electrolyte comprising said polymerised composition, a battery element comprising said electrolyte, and a method for producing said battery element.

### Technological Background

Conventional batteries, such as lithium-ion (Li-ion) type batteries, comprising a liquid electrolyte have been known for decades. However, it is known that these liquid electrolytes may affect safety of the battery, for example following the generation of metal lithium dendrites which may cause short-circuits in the battery. Furthermore, it is possible to have electrolyte leaks if sealing of the battery is defective.

More recently, a new type of battery has been developed in order to improve the performance of the battery, in particular its power and its capacity. It is the type comprising an anode made of a pure metal, more particularly of a pure alkaline metal or of a pure alkaline-earth metal, for example the metal lithium type battery having an anode made of metal lithium. However, conventional liquid electrolytes are not suited to this battery types because of the larger contact with the metal (for example metal lithium) than in batteries of the alkaline metal or alkaline-earth metal-ion type (for example Li-ion). For example, this greater contact may easily cause short-circuits.

Recently, batteries comprising a solid electrolyte (solid-state electrolyte, abbreviated: SSE) have been developed. Solid electrolytes are intended to replace liquid electrolytes in alkaline metal or alkaline-earth metal-ion type (for example Li-ion) batteries and of the type having an anode made of a pure alkaline metal or of a pure alkaline-earth metal (for example Li-metal), because they offer a solution to safety and leak problems related to liquid electrolytes.

In general, three types of solid electrolytes are considered: solid inorganic electrolytes, solid polymer electrolytes, and polymeric composite electrolytes. Several solid polymer electrolytes are known nowadays, such as a system comprising the LiN(SO₂CF₃)₂ salt dissolved in a polyethylene oxide (PEO) polymer matrix. The polyethylene oxide has ether-type coordination sites which enables the dissociation of the lithium salt and a flexible molecular chain which facilitates ion transport, such as lithium ions (Li⁺) transport. Other polymers which are currently used in solid polymer electrolytes are, inter alia, polycarbonate, polyesters, polynitriles (for example polyacrylonitrile), polyalcohols (for example polyvinyl acetate), and fluorinated polymers (for example polyvinylidene fluoride).

Document US2013157146 describes a solid polymer electrolyte having a polymer matrix comprising —(CH₂—CH₂—O)— segments (based on PEO), obtained by polymerisation of two monomers, and a lithium salt scattered in the polymeric matrix. Examples of the lithium salt include lithium perchlorate (LiCIO₄), lithium hexafluorophosphate (LiPF₆), cobalt and lithium dioxide (LiCoO₂) and iron and lithium phosphate (LiFePO₄).

However, a disadvantage of this solid polymer electrolyte type is that the electrolyte does not have the combination of mechanical properties and of ionic conductivity properties that are high enough in order to make battery elements that are dimensionally stable and having a sufficient ionic conductivity. For example, a system with a matrix based on polyethylene oxide has a good ionic conductivity but has a low mechanical stability at a temperature above the melting point of PEO (65° C.), and has a good mechanical stability thanks to the limited mobility of the chains but has a low ionic conductivity at a temperature below the melting point of PEO (65° C.).

Document ‘Single-ion BAB triblock copolymers as highly efficient electrolytes for lithium-metal batteries’, Bouchet R., Maria S., et al., Nature Materials, vol. 12, pages 452-457 (2013), describes a solution which consists in using polymers formed by an alternation of rigid blocks and soft blocks. The rigid blocks, derived from polystyrene, ensure the mechanical strength. The soft blocks, being made of polyethylene oxide, ensure a good ionic conductivity at temperatures higher than the melting point of PEO (65° C.), such as at 80° C.

Document ‘UV cross-linked, lithium-conducting ternary polymer electrolytes containing ionic liquids’, Kim G. T., Appetecchi G. B., et al., Journal of Power Sources 195 (2010), pages 6130-6137, describes a solid polymer electrolyte obtained through a cross-linking by the action of a UV radiation of a polyethylene oxide polymer matrix in the presence of LiN(SO₂CF₃)₂ (abbreviated LiTFSI) as the lithium salt and of the ionic liquid N-alkyl-N-methylpyrrolidinium TFSI. This ionic liquid has a common anion with the lithium salt, TFSI⁻. The obtained electrolyte has an ionic conductivity at room temperature of about 0.33 mS/cm.

However, the cross-linking bridges are not easy to control, which results in a random placement, leading to short chains. Thus, this considerably limits the ionic conductivity of these solid cross-linked polymer electrolytes (the value of 0.33 mS/cm is considered in the industry as being not enough for a commercial battery element). Furthermore, the use of an ionic liquid makes the formulation sticky and therefore difficult to handle.

Document WO2014126570 describes a solid polymer electrolyte comprising a lithium salt and a cross-linked polymer obtained by cross-linking the telechelic polymers having at least two photo-activable end groups. The polymers have a molecular mass before cross-linking comprised between about 1,000 Daltons and 1,000,000 Daltons. This results in a very viscous and even very crystalline composition for a solid polymer electrolyte, which deteriorates applicability over a surface such as that of an anode or of a cathode. In addition, cross-linking requires heating the composition for a duration of a several hours, typically between 3 hours and 5 hours.

### SUMMARY OF THE INVENTION

The invention aims to solve one or more of the problems of the prior art. The invention aims to provide an improved composition for a solid polymer electrolyte, which allows obtaining a solid polymer electrolyte having excellent properties in terms of ionic conductivity, mechanical stability and mechanical strength. The invention also aims to provide a method for obtaining a battery element comprising such a solid polymer electrolyte, the method being less complex, having a shorter duration and having a lower energy consumption than those of the methods of the prior art.

A first aspect of the invention relates to a polymerisable composition for a solid polymer electrolyte as described in the appended claims.

The polymerisable composition comprises a first polymer comprising a first moiety and a second moiety. The first moiety is capable of coordinating cations of an alkaline metal and/or of an alkaline-earth metal. Advantageously, the first moiety contains a polyethylene oxide (PEO) moiety. The second moiety is photo-activable and/or heat-activable. In other words, the second moiety contains a photo-activable and/or heat-activable group.

The term “photo-activable” as used in the present disclosure includes components, molecules, groups or moieties that can be activated by the action of a radiation such as—without limitation—a ultraviolet (UV) radiation, an infrared (IR) radiation, a visible light radiation, or a combination thereof.

The term “heat-activable” as used in the present disclosure includes components, molecules, groups or moieties that can be activated by the action of a temperature change. In particular, the temperature change is a heat-up. Advantageously, the activation temperature is between 20° C. and 150° C., preferably between 25° C. and 100° C.

The activation by heat and/or by a radiation includes, without limitation, an activation enabling an oligomerisation, a polymerisation or a cross-linking, and/or the initiation of an oligomerisation, a polymerisation or a cross-linking.

The polymerisable composition further contains an oligomer having at least two photo-activable and/or heat-activable groups. Advantageously, at least one of the photo-activable and/or heat-activable groups is an end group. An “end group” of the oligomer is considered as a group that is present at one end (of the chain) of the oligomer. Advantageously, at least one of the ends of the chain of the oligomer contains a photo-activable and/or heat-activable group.

Preferably, each end (of the chain) of the oligomer contains at least one photo-activable and/or heat-activable group, and the oligomer is a telechelic oligomer. A “telechelic oligomer” as used in the present disclosure is considered as an oligomer capable of undergoing a subsequent polymerisation because of the presence of at least one reactive group at each of the ends (of the chain) of the oligomer. Preferably, all photo-activable and/or heat-activable groups are end groups.

Advantageously, one or more of the second moiety of the first polymer and of the photo-activable and/or heat-activable groups of the oligomer is a maleimide.

Advantageously, the oligomer has a molar mass comprised between 500 g/mol and 5,000 g/mol, preferably between 750 g/mol and 4,000 g/mol.

The polymerisable composition further comprises a second polymer. The second polymer contains a third moiety. The third moiety comprises a salt of an alkaline metal and/or a salt of an alkaline-earth metal. Advantageously, the alkaline metal contains, or substantially consists of, lithium, and the salt is a lithium salt. Advantageously, the alkaline-earth metal contains, or substantially consists of, magnesium, and the salt is a magnesium salt.

The polymerisable composition further comprises a solvent. Advantageously, the solvent allows dissolving the components of the polymerisable composition so as to obtain a liquid polymerisable composition. This enables an easy application of the polymerisable composition to a surface, for example a surface of an electrode, for example of an anode or of a cathode. The application of the polymerisable composition in the liquid form facilitates the application in comparison with viscous or crystalline compositions.

The polymerisable composition further comprises a polymerisation initiator. The polymerisation initiator allows initiating polymerisation between the second moiety of the first polymer, the photo-activable and/or heat-activable groups of the oligomer, and advantageously the second polymer. The initiation of the polymerisation, and/or the polymerisation itself, is carried out by the action of a temperature comprised between 20° C. and 150° C., preferably between 25° C. and 100° C., or by the action of a radiation. Advantageously, the radiation contains one or more amongst a UV radiation, an IR radiation and a visible light radiation (VIS).

Advantageously, the polymerisable composition contains between and 50% by weight of the first polymer, between 1% and 20% by weight of the oligomer, between 1% and 20% by weight of the second polymer, between 20% and 60% by weight of the solvent, and between 0.01% and 2% by weight of the polymerisation initiator, based on the total weight of the polymerisable composition.

The polymerisable composition may also contain a salt of an alkaline metal and/or a salt of an alkaline-earth metal. Advantageously, the polymerisable composition comprises between 0.5% and 5% by weight of salt, based on the total weight of the polymerisable composition. Advantageously, the salt of an alkaline metal contains, or substantially consists of, a lithium salt. Advantageously, the salt of an alkaline-earth metal contains, or substantially consists of, a magnesium salt.

A second aspect of the invention relates to a solid polymer electrolyte as described in the appended claims. The solid polymer electrolyte is obtained by polymerisation of a polymerisable composition, preferably a polymerisable composition according to the first aspect of the invention. Advantageously, the polymerisation is a polymerisation between the second moiety of the first polymer, one or more of the photo-activable and/or heat-activable groups of the oligomer, and advantageously the second polymer. Advantageously, the polymerisation is carried out by the action of a temperature comprised between 20° C. and 150° C., preferably between 25° C. and 100° C., or by the action of a radiation. Advantageously, the radiation contains one or more amongst a UV radiation, an IR radiation and a visible light radiation (VIS).

Advantageously, the first polymer, the oligomer and the second polymer are polymerised in the solid polymer electrolyte. In other words, the solid polymer electrolyte according to the invention contains, or consists of, a polymeric network, advantageously a polymeric linear network.

A third aspect of the invention relates to a battery element as described in the appended claims. Advantageously, the battery element comprises the solid polymer electrolyte according to the second aspect of the invention. Thus, the battery element is a solid battery element.

Advantageously, the battery element further contains an anode and a cathode. Advantageously, the anode and/or the cathode are in contact, for example sharing one interface, with the solid polymer electrolyte. Advantageously, the anode contains an alkaline metal or an alkaline-earth metal. Advantageously, the alkaline metal contains, or consists of, lithium. Advantageously, the alkaline-earth metal contains, or consists of, magnesium.

A fourth aspect of the invention relates to a method for producing a battery element comprising a solid polymer electrolyte. In a first step, a polymerisable composition is formed. Advantageously, the polymerisable composition is according to the first aspect of the invention. The polymerisable composition is formed by mixing a first polymer, comprising a first moiety capable of coordinating cations of an alkaline metal and/or of an alkaline-earth metal and a photo-activable and/or heat-activable second moiety, an oligomer having at least two photo-activable and/or heat-activable groups, a second polymer comprising a third moiety which contains a salt of an alkaline metal or of an alkaline-earth metal and a polymerisation initiator with a solvent.

Afterwards, the polymerisable composition is applied to at least one portion of a surface of an anode and/or to at least one portion of a surface of a cathode. For example, the polymerisable composition may be applied to a surface of an anode and to a surface of a cathode.

Advantageously, the polymerisable composition is polymerisation at least partially by the action of a temperature comprised between 20° C. and 150° C., preferably between 25° C. and 100° C., or by the action of a radiation.

Advantageously, the radiation contains one or more amongst a UV radiation, an IR radiation and a visible light radiation (VIS). Thus, a partially polymerised composition is obtained.

After having polymerised the polymerisable composition at least partially, the anode and the cathode are set in contact so as to obtain a structure comprising the partially polymerised polymerisable composition positioned between the anode and the cathode. Thus, a good contact, or a good interface, between the anode and the partially polymerised polymerisable composition, and between the cathode and the partially polymerised polymerisable composition is advantageously achieved.

Then, the polymerisation of the partially polymerised polymerisable composition is completed, in order to transform the partially polymerised polymerisable composition into the solid polymer electrolyte and to obtain a battery element. The final polymerisation is carried out by exposing the cathode-composition-anode structure to a temperature comprised between 20° C. and 150° C., preferably between 25° C. and 100° C., or by the action of a radiation. Advantageously, the radiation contains one or more amongst a UV radiation, an IR radiation and a visible light radiation (VIS).

The polymerisable composition according to the invention allows obtaining solid polymer electrolytes having an excellent ionic conductivity and an excellent mechanical stability. In addition, the battery elements according to the invention contain an excellent contact (or interface) between the electrodes (the anode and the cathode) and the solid polymer electrolyte, which allows making battery elements having an excellent ionic conductivity and an improved service life duration, in comparison with battery elements of the prior art. This excellent interface is achieved in particular by the methods of the present invention.

The composition is also easy to apply to the electrodes of a battery element. The method for obtaining the solid polymer electrolyte and the battery element can particularly be implemented in mass production lines.

### BRIEF DESCRIPTION OF THE FIGURES

The aims, advantages and features are shown in the figures, which illustrate some embodiments without limitation:

FIG. 1 represents a first moiety of a component of the polymerisable composition;

FIG. 2 represents a second moiety of a component of the polymerisable composition;

FIG. 3 represents a first component of the polymerisable composition;

FIG. 4 represents a second component of the polymerisable composition;

FIG. 5 represents a third component of the polymerisable composition;

FIG. 6 represents the components of a battery element;

FIG. 7 represents the current as a function of voltage of the battery according to the invention; and

FIG. 8 represents the specific capacity of a battery after having been charged-discharged several times.

### DETAILED DESCRIPTION OF THE INVENTION

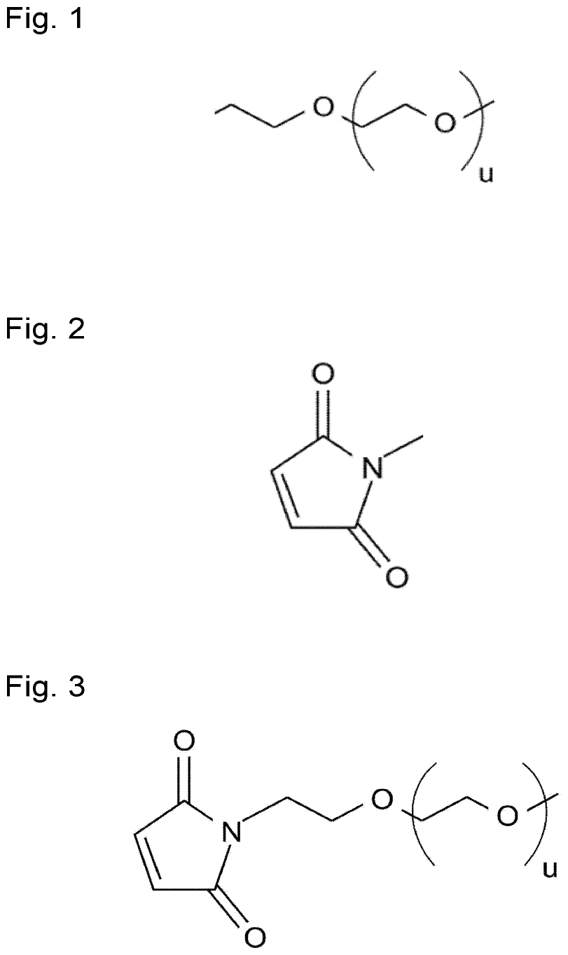

The first moiety of the first polymer of the polymerisable composition according to the invention is capable of coordinating cations of an alkaline metal and/or of an alkaline-earth metal, advantageously the cations of the alkaline metal and/or of the alkaline-earth metal in the solid polymer electrolyte according to the invention, obtained by polymerisation of the polymerisable composition. In other words, the first moiety is advantageously selected so as to ensure ionic conductivity of the solid polymer electrolyte. Non-limiting examples of the first moiety are a polyethylene oxide (PEO) as shown in FIG. 1, and a polyethylene glycol (PEG) moiety. Advantageously, in FIG. 1, u indicates the number of repetitions and is selected between 20 and 80, preferably between 30 and 70, more preferably between 40 and 60, for example between 50 and 55.

The second moiety of the first polymer of the polymerisable composition according to the invention is a moiety provided in order to enable polymerisation of the polymerisable composition in order to obtain a solid polymer electrolyte. Hence, the second moiety is photo-activable and/or heat-activable. Non-limiting examples are a maleimide moiety, as shown in FIG. 2, an acrylate moiety or a methacrylate moiety.

Advantageously, the first polymer has a molar mass comprised between 1,000 g/mol and 5,000 g/mol, preferably between 1,500 g/mol and 4,000 g/mol, such as between 2,000 g/mol and 3,000 g/mol, more preferably between 2,250 g/mol and 2,750 g/mol, for example between 2,350 g/mol and 2,600 g/mol.

Advantageously, the first polymer contains between 0.1 and 0.7 mEq (milli-equivalent) of the second moiety per gram of the first polymer, preferably between 0.2 and 0.6 mEq, more preferably between 0.3 and 0.5 mEq, for example between 0.35 and 0.45 mEq, or 0.4 mEq.

Particular examples of the first polymer are polyethylene oxide a-methoxy ω-maleimide, as shown in FIG. 3, polyethylene glycol methacrylate (PEGMA), and polyethylene glycol a-methoxy ω-maleimide.

Advantageously, the polymerisable composition contains between 10% and 50% by weight of the first polymer, preferably between 12% and 45% by weight, for example between 15% and 40% by weight, based on the total weight of the polymerisable composition.

Advantageously, when the partial or complete polymerisation, and/or the initiation of the polymerisation of the polymerisable composition takes place by the action of temperature, the temperature is comprised between 20° C. and 200° C., preferably between 20° C. and 150° C., more preferably between 25° C. and 100° C., such as between 30° C. and 80° C. In this case, the groups and moieties are heat-activable.

Advantageously, when the partial or complete polymerisation, and/or the initiation of the polymerisation of the polymerisable composition takes place by the action of a radiation, the radiation is an ultraviolet (UV) radiation, an infrared (IR) radiation, a visible light radiation, or combinations of these. In this case, the groups and moieties are photo-activable.

In the present disclosure, it is possible that the photo-activable groups and moieties are also heat-activable, and vice versa.

The polymerisable composition also contains an oligomer. The oligomer has at least two photo-activable and/or heat-activable groups. These groups can be polymerised with the second moiety of the first polymer and/or with a third moiety of a second polymer. Preferably, the groups of the oligomer can be polymerised at least with the third moiety of a second polymer. Without limitation, the photo-activable and/or heat-activable groups may be a maleimide group, an acrylate and a methacrylate.

Advantageously, the oligomer contains between 0.1 and 0.7 mEq (milli-equivalent) of photo-activable and/or heat-activable groups per gram of the oligomer, preferably between 0.2 and 0.9 mEq, more preferably between and 0.8 mEq, for example between 0.4 and 0.7 mEq, or between 0.5 and mEq.

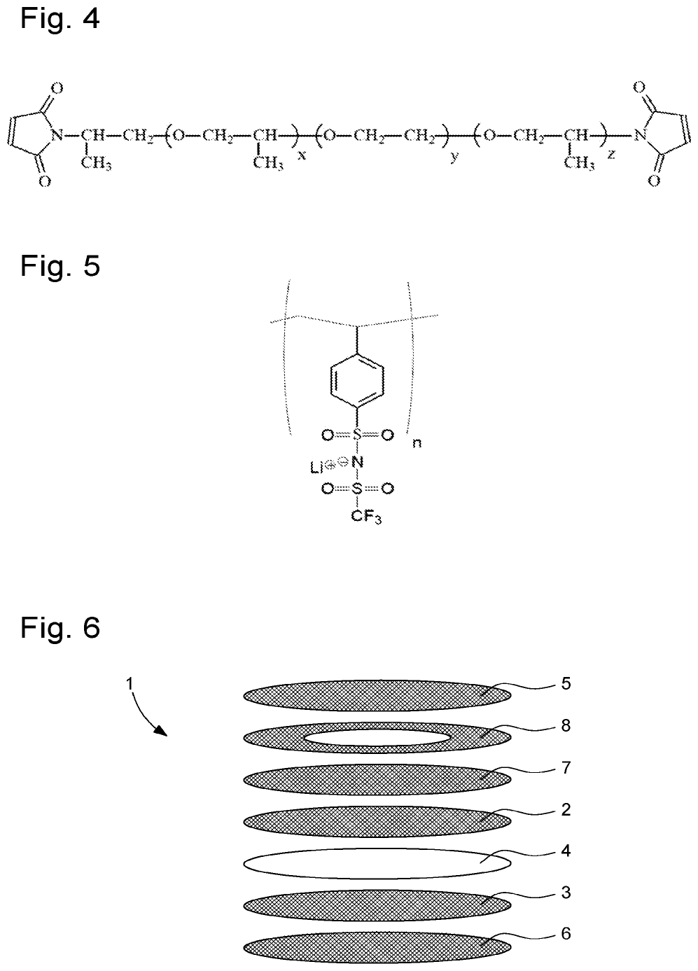

An example of the oligomer is PPG-block-PEG-block-PPG, a,ω-bis (maleimide), shown in FIG. 4. It consists of a polyethylene and polypropylene oxide (PEO-PPO) having a maleimide group at each end of the chain. Advantageously, x+z is comprised between 2 and 20, preferably between 5 and 15, more preferably between 6 and 12, for example between 8 and 9. Advantageously, y is comprised between 20 and 100, preferably between 40 and 80, more preferably between 50 and 75, for example between 60 and 70, or between 62 and 67.

Another example of the oligomer is polyethylene glycol (PEG) having a methacrylate (MA) group at each end of the chain (PEG-DiMA).

Advantageously, the oligomer has a molar mass comprised between 250 g/mol and 10,000 g/mol, preferably between 500 g/mol and g/mol, more preferably between 750 g/mol and 4,000 g/mol, for example between 1,000 g/mol and 3,750 g/mol, or between 2,000 g/mol and 3,600 g/mol.

Advantageously, the polymerisable composition contains between 1% and 20% by weight of the oligomer, preferably between 2% and 15% by weight, for example between 3% and 15% by weight, based on the total weight of the polymerisable composition.

Advantageously, the oligomer comprises at least one photo-activable and/or heat-activable group at each end of the chain of the oligomer, the oligomer being in this case a telechelic oligomer. By adding a telechelic oligomer in the polymerisable composition, it is possible to better control the polymerisation and therefore the structure of the obtained polymeric network. Advantageously, the polymeric network is a polymeric linear network. In addition, the chains between two nodes of the polymerised composition (therefore the solid polymer electrolyte) obtained in this manner are long enough so that the polymerised composition is “loose” enough and the electrolyte has an excellent ionic conductivity.

Advantageously, the oligomer is capable of acting in the solid polymer electrolyte as a plasticizer and/or an ionic conductivity amplifier of the electrolyte.

The second polymer of the polymerisable composition contains a third moiety. Advantageously, the third moiety comprises a salt of an alkaline metal and/or a salt of an alkaline-earth metal. Advantageously, the alkaline metal contains lithium, sodium, potassium, or combinations thereof. Preferably, the alkaline metal is lithium. Advantageously, the alkaline-earth metal contains magnesium, beryllium, calcium, or combinations thereof. Preferably, the alkaline-earth metal is magnesium.

Advantageously, in the obtained solid polymer electrolyte, the third moiety is capable of providing cations of the alkaline metal and/or alkaline-earth metal. Advantageously, the cations of the alkaline metal and/or alkaline-earth metal can move, in the solid polymer electrolyte, along the first polymer and the oligomer. This movement induces the ionic conductivity of the solid polymer electrolyte. In addition, being integrated to the chain of the second polymer, the third moiety also allows reducing the mobility of the counter-anions of the alkaline and/or alkaline-earth metal in the electrolyte, which allows increasing the mobility of the alkaline and/or alkaline-earth metal.

FIG. 5 shows an example of the second polymer of the polymerisable composition of the invention, wherein the third moiety is bis(trifluoromethane)sulfonimide lithium (LiSTFSI, CAS No. 210226-98-5).

Advantageously, the polymerisable composition contains between 1% and 20% by weight of the second polymer, preferably between 2% and % by weight, for example between 5% and 10% by weight, based on the total weight of the polymerisable composition.

Advantageously, the solvent in the polymerisable composition allows dissolving the components of the composition so as to obtain a liquid polymerisable composition. Advantageously, the solvent allows obtaining a liquid composition which is easy to spread over a surface. Thus, it is possible to easily apply the polymerisable composition at a surface before initiating the polymerisation at least partially. An example of the solvent includes, without limitation, propylene carbonate.

Advantageously, the polymerisable composition contains between % and 60% by weight of the solvent, preferably between 25% and 55% by weight, for example between 30% and 50% by weight, based on the total weight of the polymerisable composition.

The composition also comprises a polymerisation initiator. The polymerisation initiator allows initiating polymerisation between the second moiety of the first polymer, the photo-activable and/or heat-activable groups of the oligomer and the third moiety of the second polymer. The initiation of the polymerisation, and/or the polymerisation itself, is carried out by the action of a temperature comprised between 20° C. and 200° C., preferably between and 150° C., more preferably between 25° C. and 100° C., such as between and 80° C., or by the action of a radiation. Advantageously, the radiation contains one or more amongst a UV radiation, an IR radiation and a visible light radiation (VIS).

Advantageously, the polymerisation initiator is a radical entity. In the present disclosure, this means that the polymerisation initiator is capable of releasing radicals by the action of temperature or of a radiation as described hereinabove. Afterwards, these radicals initiate the polymerisation between the first polymer, the second polymer and the oligomer of the composition.

Examples of the polymerisation initiator include, without limitation, 2,2′-azobis(isobutyronitrile) (AIBN) and 2-hydroxy-4′-(2-hydroxyethoxy)-2-methylpropiophenone (CAS number 106797-53-9).

Advantageously, the polymerisable composition contains between % and 2% by weight of the polymerisable initiator, preferably between % and 1.5% by weight, for example between 0.25% and 1% by weight, based on the total weight of the polymerisable composition.

The polymerisable composition may also contain a salt of an alkaline metal and/or a salt of an alkaline-earth metal. Advantageously, the salt of an alkaline metal contains, or substantially consists of, a lithium salt. Advantageously, the salt of an alkaline-earth metal contains, or substantially consists of, a magnesium salt. Non-limiting examples of the salts include lithium bis(fluorosulfonyl)imide (LIFSI) and lithium bis(trifluoromethanesulfonyl) imide (LITFSI).

The Inventors have surprisingly discovered that by adding a salt of an alkaline metal and/or a salt of an alkaline-earth metal in the polymerisable composition, the obtained polymerised electrolyte has a better ionic conductivity in comparison with the electrolytes obtained from a composition without any added salt of an alkaline metal and/or salt of an alkaline-earth metal. The Inventors believe that the increased conductivity is achieved thanks to a synergy between the salt of the third moiety of the second polymer and the separate salt added in the composition.

Advantageously, if the polymerisable composition comprises a salt of an alkaline metal and/or a salt of an alkaline-earth metal, the composition contains between 0.5% and 5% by weight of the salt, preferably between % and 4% by weight, for example between 1% and 3% by weight, based on the total weight of the polymerisable composition.

A solid polymer electrolyte is obtained by polymerisation of a polymerisable composition according to the present disclosure. Advantageously, the polymerisation is a polymerisation between the second moiety of the first polymer and one or more of the photo-activable and/or heat-activable groups of the telechelic oligomer. Advantageously, the polymerisation is carried out by the action of temperature or by the action of a radiation as described hereinabove.

Advantageously, the first polymer, the oligomer and the second polymer are polymerised in the solid polymer electrolyte, thereby forming a polymeric network, advantageously a polymeric linear network.

The present disclosure also relates to a battery element comprising a solid polymer electrolyte according to the invention. Thus, the battery element is a solid battery element. The battery element may be a secondary battery.

FIG. 6 shows an embodiment of a battery element 1. The battery element 1 has a button cell type configuration, known in the prior art as the CR2032-type configuration.

The battery element 1 comprises an anode 2 and a cathode 3. In addition, the battery element 1 comprises a solid polymer electrolyte 4 between the anode 2 and the cathode 3.

Advantageously, the anode contains an alkaline metal or an alkaline-earth metal. Advantageously, the alkaline metal contains, or consists of, lithium. Advantageously, the alkaline-earth metal contains, or consists of, magnesium.

Advantageously, the battery element 1 further comprise a button cell cap 5, a button cell can 6, a spacer 7 and a spring 8. The spacer 7 and the spring 8 achieve a good contact between the other components 2, 3, 4, 5,6 of the battery element 1.

The present invention further relates to a method for producing a battery element comprising a solid polymer electrolyte. Advantageously, the battery element is a battery element according to the present disclosure. Advantageously, the solid polymer electrolyte is a solid polymer electrolyte according to the present disclosure.

First, a polymerisable composition is formed. According to a first embodiment, a first polymer comprising a first moiety capable of coordinating cations of an alkaline metal and/or of an alkaline-earth metal and a photo-activable and/or heat-activable second moiety, an oligomer having at least two photo-activable and/or heat-activable groups, a second polymer comprising a third moiety which contains a salt of an alkaline metal or of an alkaline-earth metal, a polymerisation initiator and optionally a salt of an alkaline metal and/or of an alkaline-earth metal are mixed. A solvent may be added at the same time before mixing the components, or may be added in one or more portion(s) after having mixed the components.

According to another embodiment, at least two of the components mentioned hereinbelow may be mixed, for example with a first portion of the solvent, thereby forming a first mixture. At least one, for example one or two, other mixture(s) may be formed by mixing the other components with a second portion, for example the remainder, of the solvent. Afterwards, the mixtures may be combined or mixed, thereby forming the polymerisable composition.

The formation of the polymerisable composition is not limited to these two embodiments, and other embodiments known in the prior art may also be applied.

Thus, the obtained polymerisable composition is in the liquid form. Afterwards, it is applied to at least one portion of a surface of the anode and/or to at least one portion of a surface of a cathode. For example, the polymerisable composition may be applied so as to cover an entire surface of a cathode. Advantageously, the polymerisable composition is applied to a surface of an anode and to a surface of a cathode.

The application of the polymerisable composition to a surface may be carried out by means known from the prior art, for example by moulding. Thus, a polymerisable composition layer is deposited. Advantageously, the layer has a thickness comprised between 1 μm and 1 mm, preferably between 50 μm and 750 μm, more preferably between 100 μm and 500 μm, for example between 250 μm and 400 μm. The application of the polymerisable composition in the liquid form facilitates the application in comparison with viscous or crystalline compositions.

Afterwards, the polymerisable composition is polymerised at least, and preferably, partially by the action of a temperature comprised between and 200° C., preferably between 20° C. and 150° C., more preferably between 25° C. and 100° C., such as between 30° C. and 80° C., or by the action of a radiation. Advantageously, the radiation contains one or more amongst a UV radiation, an IR radiation and a visible light radiation (VIS). Thus, a partially polymerised composition is obtained.

Advantageously, this (at least) partial polymerisation step by the action of a radiation, preferably a UV radiation, has a duration comprised between 5 seconds and 20 minutes, for example between 10 seconds and 15 minutes, preferably between 20 seconds and 10 minutes, more preferably between 30 seconds and 5 minutes, such as 4 minutes, 3 minutes, 2 minutes, 1 minute, or 55 seconds, 50 seconds or 45 seconds. Such a duration facilitates the implementation of the method in industrial production lines.

Advantageously, if the (at least) partial polymerisation is performed by the action of temperature, it has a duration comprised between 1 minute and 5 hours, preferably between 5 minutes and 4 hours, for example between minutes and 3 hours, between 20 minutes and 2.5 hours, or between 30 minutes and 2 hours.

The Inventors have discovered that this preferably partial polymerisation step before setting the anode and the cathode in contact allows avoiding short-circuiting of the electrodes. Since the polymerisable composition is liquid, it has a low mechanical strength. The at least partial polymerisation increases the mechanical strength of the composition, thereby avoiding short-circuiting of the electrodes when they are set in contact.

The Inventors have also discovered that this preferably partial polymerisation step enables a good contact (a good interface) between the electrodes and the partially polymerised composition. This also enables a good contact between the two layers of the partially polymerised composition if the composition is applied to the anode and to the cathode.

Afterwards, the anode and the cathode are set in contact so as to obtain a structure comprising the partially polymerised polymerisable composition positioned between the anode and the cathode. Thus, a good contact, or a good interface, between the anode and the partially polymerised polymerisable composition, and between the cathode and the partially polymerised polymerisable composition is achieved. This allows obtaining battery elements having an excellent ionic conductivity.

Then, the polymerisation of the polymerisable composition which is partially polymerised is completed, in order to convert the partially polymerised polymerisable composition into the solid polymer electrolyte and to obtain a battery element. The final polymerisation is done by exposing the cathode-composition-anode structure at a temperature comprised between and 200° C., preferably between 20° C. and 150° C., more preferably between 25° C. and 100° C., such as between 30° C. and 80° C., or by the action of a radiation. Advantageously, the radiation contains one or more amongst a UV radiation, an IR radiation and a visible light radiation (VIS). Thus, a polymerised composition is obtained.

Advantageously, this final or complete polymerisation step by the action of a radiation, preferably a UV radiation, has a duration comprised between 5 seconds and 20 minutes, for example between 10 seconds and minutes, preferably between 20 seconds and 10 minutes, more preferably between 30 seconds and 5 minutes, such as 4 minutes, 3 minutes, 2 minutes, 1 minute, or 55 seconds, 50 seconds or 45 seconds. Such a duration facilitates the implementation of the method in industrial production lines.

Advantageously, if the final or complete polymerisation is performed by the action of temperature, it has a duration comprised between 1 minute and 10 hours, preferably between 10 minutes and 7.5 hours, for example between 30 minutes and 5 hours, between 45 minutes and 4 hours, or between 1 minutes and 3 hours.

According to a second embodiment of the method, the polymerisable composition is first partially polymerised, and it is applied afterwards to at least one portion of a surface of the anode and/or to at least one portion of a surface of a cathode. Then, the polymerisation is completed.

### Example

A polymerisable composition has been produced by adding 0.6 grams of polyethylene oxide a-methoxy ω-maleimide (a first polymer), 0.085 grams of PPG-block-PEG-block-PPG, a,ω-bis(maleimide) (a telechelic oligomer), 0.14 grams of STFSILi (a third moiety of the second polymer), grams of LiFSI (a lithium salt) to 0.75 grams of carbonate propylene (the solvent). Afterwards, the solution has been stirred for 12 hours. After 12 hours, 0.0125 grams of AIBN as the polymerisation initiator have been added and the polymerisable composition has been stirred for 10 minutes.

Afterwards, the composition has been applied over an anode comprising lithium titanate (Li₂TiO₃, denoted LTO), and over a cathode comprising iron and lithium phosphate (LiFePO₄, denoted LFP). Afterwards, the electrodes covered with the composition have been subjected to a UV radiation for 1 minute at 200 W (OMNICURE Series 2000, wavelength comprised between 320 nm-500 nm) in order to polymerise the composition at least partially.

Afterwards, the anode and the cathode with the composition at least partially polymerised have been set in contact and have been deposited in a CR2032-type case containing 3 stainless steel disks having a 0.8 mm thickness and a 17 mm diameter. The case has been sealed using a press.

Then the polymerisation has been completed by heating the whole in an oven at 80° C. for 3 hours.

The ionic conductivity of the solid polymer electrolyte has been measured by electrochemical impedance spectroscopy (EIS) at different temperatures, followed by measurement of the ionic conductivity according to the formula (I) wherein

$$σ = \frac{I}{{R}_{b} * S} \qquad ( 1 )$$

σ represents the ionic conductivity,
Rb represents the measured resistance,
I represents the thickness of the solid polymer electrolyte, and
S represents the surface area of the electrolyte.

The ionic conductivity measured in this manner was 0.51 mS/cm, which is above the minimum value of 0.1 mS/cm which guarantees enough ionic conductivity.

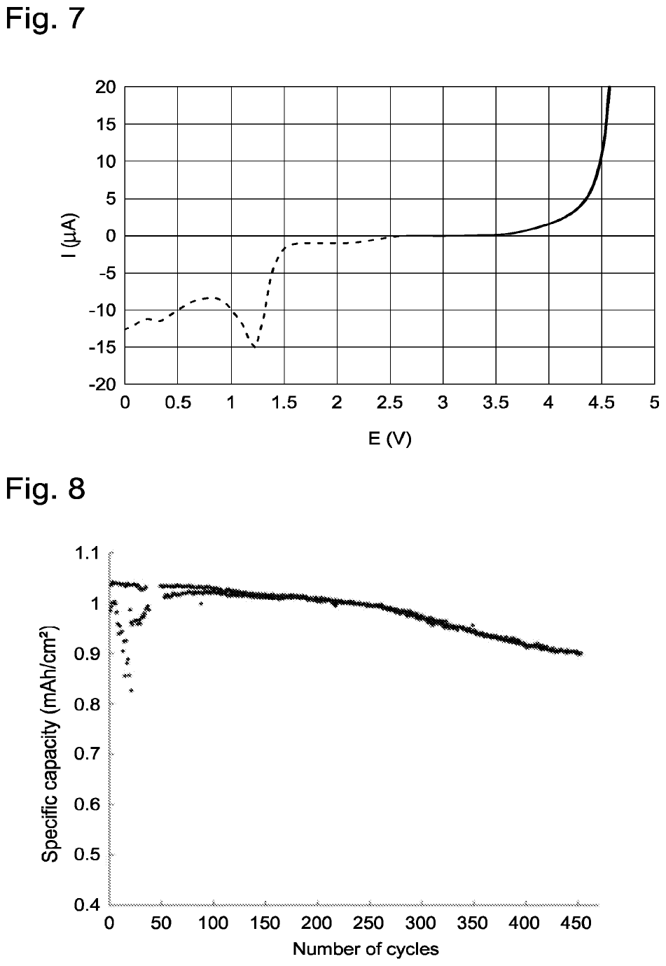

FIG. 7 shows current as a function of voltage. It is obvious that the electrochemical stability window of the electrolyte is from 1.5 V to 4 V.

The service life duration of the battery has been tested by charging and discharging the battery for more than 450 cycles between 1.4 V and 1.5 V. The cycling rate was C/20, which corresponds to a 0.1 mA charging. Charging has been done by applying a constant current and the discharge has been done by applying the same current but negatively. During each cycle, the battery has been charged and discharged to 100%.

The results are shown in FIG. 8, which represents the specific capacity as a function of the number of cycles, wherein one cycle means a complete charging-discharge cycle. It arises from FIG. 8 that the specific capacity loss after 200 cycles is below 5% with respect to the specific capacity of the first cycle. Hence, it is obvious that the battery has an excellent capacity stability and therefore an excellent resistance to repeated charging and discharge and therefore an excellent service life duration.

### LIST OF REFERENCES

1. battery element
2. anode
3. cathode
4. solid polymer electrolyte
5. button cell cap
6. button cell can
7. spacer
8. spring

1. A polymerisable composition for a solid polymer electrolyte comprising:
a first polymer comprising a first moiety and a second moiety, the first moiety being capable of coordinating cations of an alkaline metal and/or of an alkaline-earth metal, the second moiety being photo-activable and/or heat-activable;
an oligomer having at least two photo-activable and/or heat-activable groups;
a second polymer comprising a third moiety, the third moiety comprising a salt of an alkaline metal or of an alkaline-earth metal;
a solvent; and
a polymerisation initiator;
characterised in that wherein the polymerisation initiator allows initiating polymerisation between the second moiety of the first polymer and the photo-activable and/or heat-activable groups of the oligomer by the action of a temperature comprised between 20° C. and 150° C. or of a radiation.

2. The polymerisable composition according to claim 1, comprising between 10% and 50% by weight of the first polymer, between 1% and 20% by weight of the oligomer, between 1% and 20% by weight of the second polymer, between 20% and 60% by weight of the solvent, and between 0.01% and 2% by weight of the polymerisation initiator, based on the total weight of the polymerisable composition.

3. The polymerisable composition according to claim 1, further comprising a salt of an alkaline metal and/or a salt of an alkaline-earth metal.

4. The polymerisable composition according to claim 3, comprising between 0.5% and 5% by weight of salt, based on the total weight of the polymerisable composition.

5. The polymerisable composition according to claim 1, wherein the first moiety contains a polyethylene oxide moiety.

6. The polymerisable composition according to claim 1, wherein at least one of the photo-activable and/or heat-activable groups is an end group.

7. The polymerisable composition according to claim 6, wherein all of the photo-activable and/or heat-activable groups of the oligomer are end groups, and the oligomer is a telechelic oligomer.

8. The polymerisable composition according to claim 1, wherein one or more of the second moiety and of the photo-activable and/or heat-activable groups is a maleimide.

9. The polymerisable composition according to claim 1, wherein the oligomer has a molar mass comprised between 500 g/mol and 5,000 g/mol.

10. A solid polymer electrolyte obtained by polymerisation of a polymerisable composition according to claim 1, wherein the polymerisation is a polymerisation between the second moiety of the first polymer, the photo-activable and/or heat-activable groups of the oligomer and advantageously the second polymer by the action of a temperature comprised between 20° C. and 150° C. or of a radiation.

11. The solid polymer electrolyte according to claim 9, wherein the polymerisation is carried out by action of a UV radiation.

12. A battery element, comprising the solid polymer electrolyte according to claim 10.

13. The battery element according to claim 12, further comprising an anode comprising an alkaline metal or an alkaline-earth metal.

14. The battery element according to claim 13, wherein the alkaline metal is lithium or the alkaline-earth metal is magnesium.

15. A method for producing a battery element according to claim 12, comprising the steps of:
mixing a first polymer comprising a first moiety and a second moiety, the first moiety being capable of coordinating cations of an alkaline metal and/or of an alkaline-earth metal, the second moiety being photo-activable and/or heat-activable, an oligomer having at least two photo-activable and/or heat-activable groups, a second polymer comprising a third moiety, the third moiety comprising a salt of an alkaline metal or of an alkaline-earth metal and a polymerisation initiator in a solvent, thereby obtaining a polymerisable composition;
polymerising at least partially the polymerisable composition by the action of a temperature comprised between 20° C. and 150° C. or of a radiation;
applying the partially polymerised polymerisable composition to at least one portion of a surface of an anode and/or to at least one portion of a surface of a cathode;
setting the anode and the cathode in contact so as to obtain a structure comprising the partially polymerised polymerisable composition positioned between the anode and the cathode; and
completely polymerising the partially polymerised polymerisable composition by the action of a temperature comprised between 20° C. and 150° C. or of a radiation, thereby obtaining a battery element comprising a solid polymer electrolyte.
